(19) United States
(12) Patent Application Publication
(10) Pub. No.: US 2020/0338710 A1
(43) Pub. Date: Oct. 29, 2020

(54) POWER TOOL COOPERATION CONTROL/FEEDBACK/SENSOR SYSTEM

(71) Applicant: TECHTRONIC CORDLESS OFGP, Anderson, SC (US)

(72) Inventors: Ngai CHEUNG, Hong Kong (CN); Dianwu XU, Dongguan City (CN)

(21) Appl. No.: 16/962,351

(22) PCT Filed: Jan. 26, 2018
(86) PCT No.: PCT/CN2018/074349

§ 371 Date: Jul. 15, 2020

(51) Int. Cl. B25F 5/00; H04W 4/80; H04B 1/3827

(52) U.S. Cl. CPC B25F 5/00; H04B 1/3827; H04W 4/80

(57) ABSTRACT

A power tool system has a dominant tool and a linked tool. The dominant tool contains a dominant tool power switch and a dominant tool transceiver operatively-connected to the dominant tool power switch. The linked tool contains a linked tool power switch and a linked tool transceiver operatively-connected to the linked tool power switch. When the dominant tool power switch is engaged, the dominant tool transceiver sends a wireless signal; or a start signal, to the linked tool transceiver to activate the linked tool power switch. A mesh network containing the power tool system and a method for controlling a linked tool are also provided.

### CROSS-REFERENCE TO RELATED APPLICATIONS

This application is a national phase filing under 35 U.S.C. 371 of International Application No. PCT/CN2018/074349, filed Jan. 26, 2018, the entire contents of which are incorporated herein by reference.

### FIELD

The present invention is related to the field of tools, and more specifically to interactive power tool systems.

### SUMMARY

Power tools are often used at locations such as construction sites, houses, workplaces, etc. and oftentimes multiple tools will be used at the same time. For example, a carpenter may use a drill, an impact hammer, a sander, etc. all during the same day and may also simultaneously need to use a light, a fan, a vacuum, etc. However, it may be difficult to coordinate use of multiple tools when working alone. Especially if a tool needs to be held in each hand during operation, then the manipulation and use of multiple tools may require additional people, special stands, etc.

It would also be useful to provide feedback to a plurality of tools while using a single tool. It would also be useful to be able to transmit data from one tool to another tool.

Accordingly, the need exists for a power tool system that better coordinates between different tools, and/or is easier for a single person to use. Furthermore the need remains for improved feedback and/or data transfer between tools, as well as easier communication about the tool status and use with the user.

An embodiment of the present invention relates to a power tool system having a dominant tool and a linked tool The dominant tool contains a dominant tool power switch and a dominant tool transceiver operatively-connected to the dominant tool power switch. The linked tool contains a linked tool power switch and a linked tool transceiver operatively-connected to the linked tool power switch. When the dominant tool power switch is engaged, the dominant tool transceiver sends a wireless signal; or a start signal, to the linked tool transceiver to activate the linked tool power switch.

An embodiment of the present invention relates to a mesh network containing the dominant power tool and linked power tool as described herein.

Another embodiment of the present invention relates to a method for controlling a linked tool having the steps of providing a dominant tool and providing a linked tool. The dominant tool contains a dominant tool power switch and a dominant tool transceiver operatively-connected to the dominant tool power switch. The linked tool contains a linked tool power switch and a linked tool transceiver operatively-connected to the linked tool power switch. The method further includes the steps of transmitting a wireless signal; or a start signal, from the dominant tool transceiver to the linked tool transceiver, receiving the wireless signal; or the start signal, by the linked tool transceiver, and activating the linked tool power switch.

Without intending to be limited by theory, it is believed that the invention herein may help a user by reducing the need to individually turn on different tools, may reduce energy consumption, may reduce noise, may better coordinate between different tools; may provide improved feedback and/or data transfer between tools, and/or provide easier communication about the tool status and use with the user.

### BRIEF DESCRIPTION OF THE DRAWINGS

FIG. 1 shows a schematic diagram of an embodiment of the power tool system;

FIG. 2 shows a schematic diagram of an embodiment of the power tool system which is similar to that seen in FIG. 1, except that only a single linked tool is present; and

FIG. 3 shows a schematic diagram of an embodiment of the power tool system, in which the dominant tool has a linked tool, and the linked tool, also acts as a dominant tool with respect to a second linked tool. The figures herein are for illustrative purposes only and are not necessarily drawn to scale.

### DETAILED DESCRIPTION

Unless otherwise specifically provided, all measurements are made in metric units.

Furthermore, all percentages, ratios, etc. herein are by weight, unless specifically indicated otherwise.

The present invention relates to a power tool system containing a dominant tool and a linked tool. The dominant tool contains a dominant tool power switch and a dominant tool transceiver operatively-connected to the dominant tool power switch. The linked tool contains a linked tool power switch and a linked tool transceiver operatively-connected to the linked tool power switch.

When the dominant tool power switch is engaged, the dominant tool transceiver sends a wireless signal; or a start signal, to the linked tool transceiver. When the linked tool transceiver receives the wireless signal; or the start signal, then the linked tool power switch is activated and the linked tool starts operation. Without intending to be limited by theory, it is believed that such a system is especially useful to provide remote starting of a linked tool so that the user does not need to separately start the linked tool. This in turn may allow the user to focus more on the use of the dominant tool.

In an embodiment herein, the dominant tool is selected from the group of a spray device, a garden care device, a power tool, a cutting device, an applicator, a motor, a generator, and a combination thereof. In an embodiment herein, the dominant tool is a precision tool and therefore requires more specific attention during use than the linked tool.

In an embodiment herein, the spray device is selected from the group of a paint sprayer, a water sprayer, an insecticide sprayer, a fertilizer sprayer, a power sprayer, a high pressure sprayer, and a combination thereof. In an embodiment herein, the garden care device herein is selected from the group of a mowing device, a blowing device, a trimming device, and a combination thereof; or a lawn mower, a leaf blower, a grass trimmer, a tree trimmer, a hedge trimmer, an edger, a mulcher, and a combination thereof. In an embodiment herein, the power tool herein is selected form the group of a sander, a finisher, a fastener, a cutting device, a drill, a grinder, a screwdriver, a jackhammer, a nail or fastener gun, a lathe, a pneumatic wrench, a pneumatic clamp, an expansion tool, a crimper, a polisher, a router, a pneumatic hammer, an impact hammer, a knockout tool, a coring tool, and a combination thereof. In an embodiment herein the cutting device is selected from the group of a circular saw, a band saw, a chainsaw, a reciprocating saw, a table saw, a radial arm saw, a rotary saw, a miter saw, a concrete saw, an abrasive saw, a jig saw, a scroll saw, shears, a cutter, a cut out tool, a nibbler, a laser leveller, and a combination thereof. In an embodiment herein, the applicator is selected from the group of a paint applicator, a glue applicator, a soldering iron, and a combination thereof. In an embodiment herein, the motor is selected from the group of a generator, a winch, a hoist, and a combination thereof. In an embodiment herein, the generator is an electric generator which is powered by, for example, gasoline, diesel, kerosene, light, propane, butane, and a combination thereof.

In an embodiment herein, the power tool system herein contains from about 1 to about 200 dominant tools; or from about 1 to about 150 dominant tools; or from about 1 to about 100 dominant tools; or from about 2 to about 200 dominant tools; or from about 2 to about 150 dominant tools; or from about 2 to about 100 dominant tools.

In an embodiment herein, the linked tool is selected from the group of a vacuuming device, a heating device, a lighting device, a sound device, and a combination thereof.

In an embodiment herein, the vacuuming device is selected from the group consisting of a wet vacuum, a dry vacuum, a hand vacuum, a mulcher/vacuum, and a combination thereof. In an embodiment herein, the heating device is selected from the group consisting of a gas heater, an electric heater, and a combination thereof; or a space heater, a blow dryer, a fan heater, and a combination thereof. In an embodiment herein, the lighting device is selected form the group consisting of a cordless light, a LED light and a combination thereof; or is selected from the group consisting of a hand held light, a spotlight, an area light, a flood light, a tower light, a helmet light, a belt light, a harness light, a room light, and a combination thereof. In an embodiment herein, the sound device is selected from the group consisting of a megaphone, a microphone, a speaker, a radio, a cell phone, a walkie-talkie, and a combination thereof.

In an embodiment herein, the power tool system herein contains from about 1 to about 200 linked tools; or from about 1 to about 150 linked tools; or from about 1 to about 100 linked tools; or from about 2 to about 200 linked tools; or from about 3 to about 150 linked tools; or from about 4 to about 100 linked tools.

In an embodiment herein, the dominant tool and the linked tool will both typically be electric tools, although these tools may also contain internal combustion engines or motors either in addition to or replacing electric motors. The dominant tool and/or the linked tool may be powered by AC current or DC current. Furthermore, in an embodiment herein, hybrid (combined AC/DC) tools are also useful herein as either the dominant tool and/or the linked tool.

In an embodiment herein, the dominant tool contains a battery operatively-connected to the dominant tool transceiver. In an embodiment herein, the battery is operatively-connected to the dominant tool power switch. Furthermore, in an embodiment herein, the dominant tool transceiver is located in, on, or near the battery itself; or in, on, or near the battery of the dominant tool.

In In an embodiment herein, the linked tool contains a battery operatively-connected to the linked tool transceiver. In an embodiment herein, the battery is operatively-connected to the linked tool power switch. Furthermore, in an embodiment herein, the linked tool transceiver is located in, on, or near the battery itself; or in, on, or near the battery of the linked tool.

In an embodiment herein, the dominant tool transceiver in the dominant tool is a transceiver which is capable of both transmitting and receiving wireless signals. In an embodiment herein, the linked tool transceiver in the linked tool is a transceiver which is capable of both transmitting and receiving wireless signals. Without intending to be limited by theory, it is believed that it may be beneficial in many cases if the dominant tool and the linked tool may communicate in both directions between themselves. For example, in addition to a start signal being sent form the dominant tool to the linked tool, a confirmation signal may be sent form the linked tool to the dominant tool.

In an embodiment herein, the dominant tool, the linked tool, or both the dominant tool and the linked tool further contain a controller. The controller is operatively-connected to the battery, the dominant tool transceiver, the linked tool transceiver, and/or the power switch as desired. The controller useful herein is typically a printed circuit board, a microprocessor, a computer and/or other electronic control mechanism as known in the art.

In an embodiment herein, the transceiver is respectively a wireless transceiver. The wireless transceiver may communicate via a wireless signal. Furthermore, the wireless transceiver may wirelessly-communicate with a technology, standard, and/or protocol selected from the group of near field communication (NFC), proximity card, radio frequency identification (RFID), Wi-Fi, Bluetooth™, ZigBee™, 3G, 4G, 5G, 6G, NB-IOT, LTE, and/or other wireless communication systems and/or protocols as desired, and a combination thereof; or Wi-Fi, Bluetooth™, NFC and a combination thereof. Such wireless technologies, standards and protocols useful herein are well-known in the wireless communications art. In an embodiment herein, the power tool system forms; or is part of, a mesh network; or the dominant tool and the linked tool form a mesh network, optionally wherein the wireless signal; or the start signal, is transmitted over the mesh network. In an embodiment of the power tool system herein, a plurality of wireless signals are sent between the dominant tool and the linked tool.

In an embodiment herein, the user and/or owner may configure the mesh network, the communication nodes, etc. either via a web interface, a mobile device, a control panel on one or more tools, etc. In an embodiment herein, the user and/or the owner may configure the communication nodes. In an embodiment herein, the optional mobile device may be, for example, a tablet computer, a mobile phone, smart watch, or a combination thereof; or a smartphone.

The wireless signal useful herein may contain any type of data and may be, for example, a start signal, a stop signal, a confirmation signal, a status signal, an error signal, a warning signal, and a combination thereof.

In an embodiment herein the dominant tool transceiver periodically sends a wireless signal to the linked tool transceiver; or to multiple linked tool transceivers. In an embodiment herein the dominant tool transceiver sends the wireless signal at a rate of from about 0.001 Hz to about 10,000 Hz. In an embodiment herein, the linked tool transceiver receives a wireless signal at a rate of from about 0.001 Hz to about 10,000 Hz. In an embodiment herein, the dominant tool contains a controller operatively-linked to the dominant tool transceiver, the linked tool contains a controller operatively-linked to the linked tool transceiver, and the controller operatively-linked to the linked tool transceiver checks for a wireless signal at a rate of from about 0.001 Hz to about 10,000 Hz.

In an embodiment herein, the dominant tool is a wireless communication node capable of both sending and receiving a wireless signal. In an embodiment herein, the linked tool is a wireless communication node, and wherein the number of wireless communication nodes is from about 2 to about 32767; or from about 2 to about 10000 wireless communication nodes; or from about 2 to about 1000 wireless communication nodes; or from about 2 to about 2000 wireless communication nodes; or from about 2 to about 1500 wireless communication nodes.

In an embodiment herein, each individual tool in the plurality of tools is a powered tool, such as an electric, gasoline, fuel cell, or hybrid tool. The electric and/or hybrid tools may run on DC and/or AC current. In an embodiment herein, the electric tool contains an electric power source. In an embodiment herein, the electric power source is a DC battery. The battery chemistry is largely irrelevant, but may be, for example nickel-cadmium, lithium ion, nickel metal hydride, lead acid, nickel hydrogen, and a combination thereof; or lithium ion. Generally, higher energy-density DC batteries are preferred. The battery useful herein may be, for example, a replaceable battery, a rechargeable battery, a disposable battery, and a combination thereof.

In an embodiment herein, the power tool system contains a sensor; or a plurality of sensors. In an embodiment herein, the sensor is located at a sensor position selected from in, on, and/or affixed to the dominant tool, the linked tool, and a combination thereof. The sensor useful herein may be selected from the group of a temperature sensor, a humidity sensor, a light sensor, an air quality sensor, a location sensor, a proximity sensor, a power sensor, a sound sensor, a pH sensor, an attitude sensor, a barometer, a level sensor, an angle sensor, a pressure sensor, an impact sensor, a hall effect sensor, a RPM sensor, and a combination thereof. In an embodiment herein, the sensor generates data.

In an embodiment herein, the controller contains an instruction set having a condition dependent on a set of conditions; or dependent upon the data; or dependent upon the data from the sensors herein. When the controller receives a start signal and when the condition is satisfied, the controller executes the instruction set. In an embodiment herein, the instruction set is selected from the group of a default instruction set and a user-defined instruction set; or wherein the user-defined instruction set is programmed from a programming location selected from the group selected from the group of a mobile device, a control panel on the dominant tool, a control panel on the linked tool, a website, a cloud server, and a combination thereof.

In an embodiment herein, the sensor generates data at a rate of from about 0.001 Hz to about 10,000 Hz. In an embodiment herein, the data is transmitted to the dominant tool, the linked tool, or a combination thereof.

The power tool system herein may further contain and/or connect to a communications network and/or device, such as, for example, the internet, the cloud, a mobile device, a Wi-fi hub, a full mesh network, a partial mesh network, a wireless local area network, a and a combination thereof. In an embodiment herein, the mobile device is selected from the group of a mobile phone, a tablet computer, and a combination thereof; or a mobile phone, a tablet computer, and a combination thereof. Such embodiments may be useful, for example, if the dominant tool and/or the linked tool; or their respective controllers, need to be accessed and/or controlled from a remote location, when checking on the statuses of the tools, etc.

In an embodiment herein, the wireless signal may be sent either directly from the dominant tool transceiver to the linked tool transceiver or broadcast to the entire network; or mesh network.

In an embodiment herein, the dominant tool herein is an IoT (Internet of Things) device. In an embodiment herein, the linked tool is an IoT device. As used herein, the term Internet of Things and the associated acronym of IoT indicates a networked device which is able to share data with other networked devices through the combination of embedded software, electronics, sensors, actuators, and/or network connections. See, for example: https://en.wikipedia.org/wiki/Internet_of_things.

### Method for Controlling a Linked Tool

In an embodiment herein, the invention relates to a method for controlling a linked tool having the steps of providing a dominant tool and providing a linked tool. The dominant tool has a dominant tool power switch and a dominant tool transceiver operatively-connected to the dominant tool power switch. The linked tool has a linked tool power switch and a linked tool transceiver operatively-connected to the linked tool power switch. The method for controlling a linked tool further contains the steps of transmitting a start signal from the dominant tool transceiver to the linked tool transceiver, receiving the start signal by the linked tool transceiver, and activating the linked tool power switch.

Without intending to be limited by theory, it is believed that such a method may significantly save time, effort, and/or reduce frustration for the user. In addition, it is believed that such a method may reduce the hassle of using multiple tools at the same time.

In an embodiment of the present invention, the invention herein, and particularly the linked tool's controller herein, further includes a deactivation step and/or a deactivation function. The deactivation step and/or deactivation function typically deactivates the linked tool power switch upon receiving a stop signal from the dominant tool, and/or after a predetermined period of time. Thus, in an embodiment herein, when the user deactivates the dominant tool power switch, the dominant tool transceiver transmits a stop signal which is received by the linked tool transceiver. The linked tool transceiver then sends the stop signal to the controller which may deactivate the linked tool power switch immediately, or after a predetermined period of time.

In an alternate embodiment herein, the deactivating step occurs after a predetermined period of time has passed from the initial receipt of the start signal by the linked tool; or the linked tool transceiver; or the controller.

In an embodiment herein the predetermined period of time is from about 1 minute to about 45 minutes; or from about 2 minutes to about 30 minutes; or from about 3 minutes to about 25 minutes.

In some cases, the linked tool may be located distal from the use and the dominant tool. In such a case, the triggering of the power switch by the linked tool's controller may save significant effort as the user does not need to go to the linked tool and turn it on or off every time it is used. In other cases, where the linked tool is proximal to the user and/or the dominant tool, then it is believed that the activation of the linked tool may reduce the complexity of the job. In either manner, the method herein may ensure that the linked tool is only used when it is needed, thereby saving energy (e.g., electricity), and the effort of the user. Without intending to be limited by theory, it is believed that such an activation and/or deactivation step may, for example, save energy, allow the user to focus on other steps, save effort, etc.

In an embodiment herein the method herein may further contain the step of activating a notification, such a s an audio notification, a visual notification, a vibratory notification, and a combination thereof. Without intending to be limited by theory it is believed that such a notification may provide useful information to the user, or others around the user. For example, such a notification may indicate, for example, that the linked tool has received a signal and understands it, is complying with it, etc. Alternatively the notification may indicate that either the dominant tool or the linked tool cannot find the other tool, that the wireless signal is blocked, that the other tool is out of ranger, etc. Alternatively, such a notification may indicate that the dominant tool, the linked tool, or both are running out of energy, are fully charged, are overheating, require maintenance, etc. In an embodiment herein, the notification may be deactivated in a deactivating step, by, for example, the user, the dominant tool, and/or the linked tool.

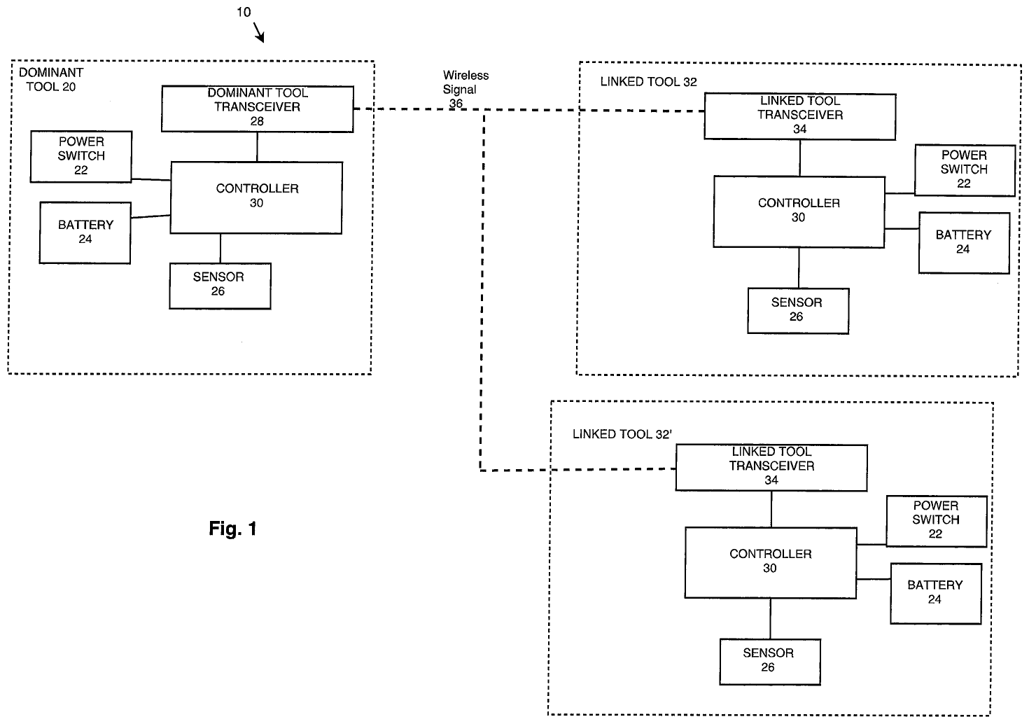

Turning to the figures, FIG. 1 shows a schematic diagram of an embodiment of the power tool system herein. The power tool system, 10, has a dominant tool, 20, containing a power switch, 22, a battery, 24, a sensor, 26, and a dominant tool transceiver, 28, all operatively-connected to a controller, 30. In FIG. 1, the battery, 24, is operatively-connected to the power switch, 22, the dominant tool transceiver, 28, and the sensor, 26, via the controller, 30. Furthermore, all of the battery, 24, the power switch, 22, the dominant tool transceiver, 28, and the sensor, 26, are operatively-connected to each other via the controller, 30

The embodiment of FIG. 1 also shows a linked tool, 32, and another linked tool, 32′. Both linked tools, 32 and 32′, contain a linked tool transceiver, 34, a power switch, 22, a battery, 24, and a sensor, 26, operatively-connected to a controller, 30. The battery, 24, is operatively-connected to the power switch, 22, the linked tool transceiver, 34, and the sensor, 26, via the controller, 30. Furthermore, all of the battery, 24, the power switch, 22, the linked tool transceiver, 34, and the sensor, 26, are operatively-connected to each other via the controller, 30.

In the embodiment of FIG. 1, the dominant tool transceiver, 28, is operatively-connected to the dominant tool's, 20, power switch, 22, via the controller, 30. Each of the linked tool's, 32 and 32′, linked tool transceiver, 34, is operatively-connected to the linked tool's, 32 and 32′, power switch, 22. When the power switch, 22, of the dominant tool, 20, is activated, the controller, 30, instructs the dominant tool transceiver, 28, to send a wireless signal, 36, which in this case is a start signal.

The linked tool transceiver, 34, in the linked tools, 32 and 32′, receive the wireless signal, 36, and send it to the controller, 30 in the linked tools, 32, and 32′. In the linked tools, 32 and 32′, the controller, 30, may also receive data from the operatively-connected sensor, 26. The controller, 30, may then evaluate the start signal, the sensor data, etc. and activate the power switch, 32, of the linked tools, 32 and 32′.

When the user is finished using the dominant tool, 20, the user deactivates the power switch, 22. The dominant tool, 20, may in turn send a wireless signal, 36, via the controller, 30, and then the dominant tool transceiver, 28, which in this case is a stop signal. In the linked tools, 32 and 32′, the respective linked tool transceivers, 34, receive the stop signal, and send it to the controller, 30, which then deactivates the power switches, 22. Such a deactivating of the power switches, 22, may be immediately, or after a predetermined time, as desired.

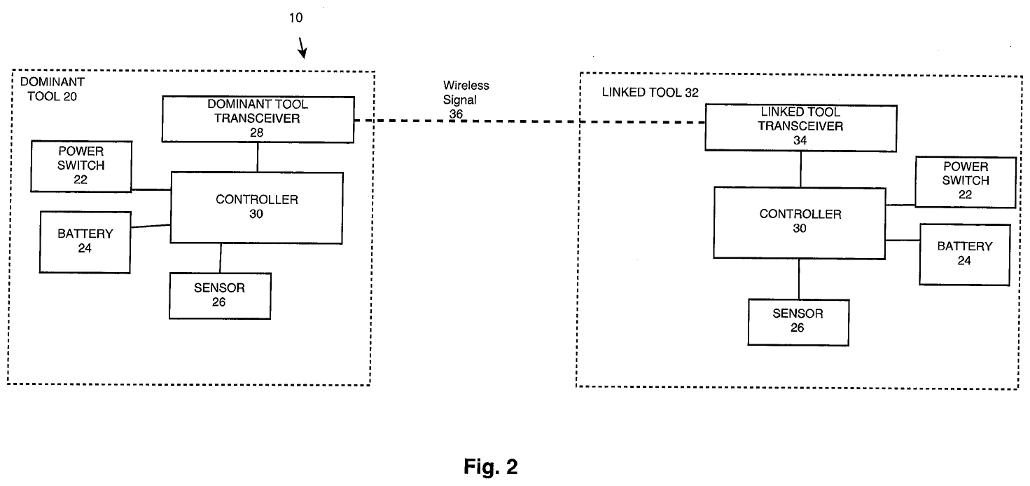

FIG. 2 shows a schematic diagram of an embodiment of the power tool system, 10, which is similar to that seen in FIG. 1, except that only a single linked tool is present. The dominant tool, 20, has a power switch, 22, a dominant tool transceiver, 28, a battery, 24, and a sensor, 26, all operatively-connected to a controller, 30, and also operatively connected to each other. The linked tool, 32, contains a linked tool transceiver, 34, a power switch, 22, a battery, and a sensor, 26, all operatively-connected to the controller, 30, and also operatively connected to each other.

In FIG. 2, the linked tool, 32, may send, for example, battery information, temperature information, status information, sensor data, etc. to the dominant tool, 20, via the wireless signal, 36.

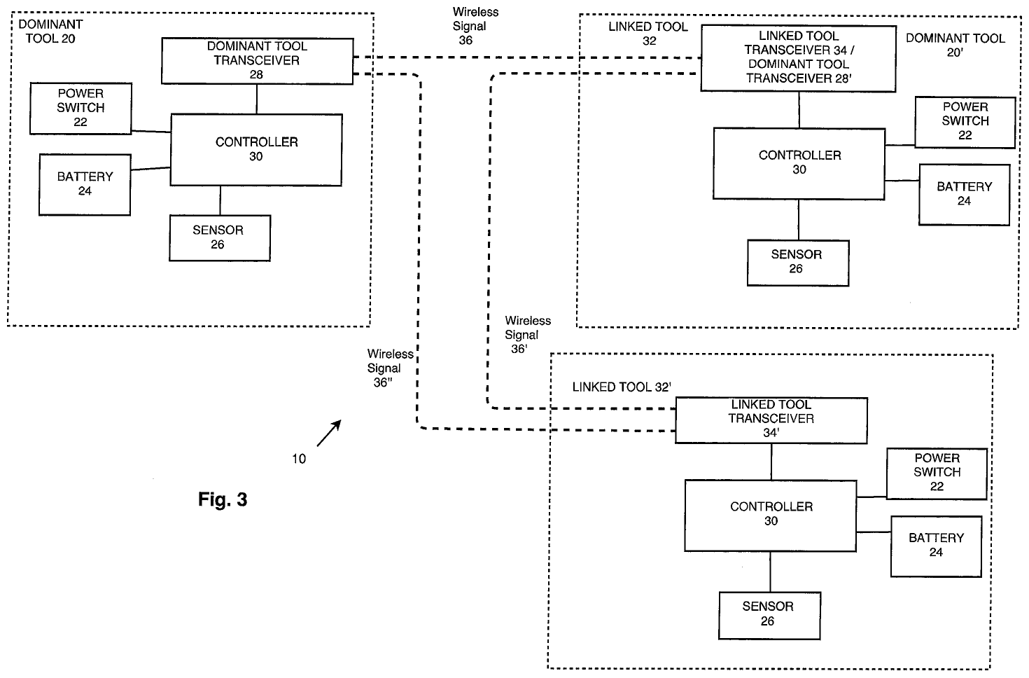

FIG. 3 shows a schematic diagram of an embodiment of the power tool system, 10, in which the dominant tool, 20, has a linked tool, 32. Furthermore, the linked tool, 32, also acts as a dominant tool, 20′, with respect to the linked tool, 32′. Accordingly, the dominant tool, 20, contains a power switch, 22, a battery, 24, a sensor, 26, and a dominant tool transceiver, 28, operatively-connected to a controller, 30, and also operatively connected to each other. The linked tool, 32, contains a power switch, 22, a battery, 24, a sensor, 26, and a linked tool transceiver, 34, operatively-connected to a controller, 30, and also operatively connected to each other.

The dominant tool transceiver, 28, of the dominant tool, 20, sends a wireless signal, 36, to the linked tool transceiver, 38, of the linked tool, 32, which then sends the signal to the controller, 30, which then may activate the power switch, 22. In addition, since the linked tool, 32, also acts as a dominant tool, 20′, the controller, 30, of the dominant tool, 32′, instructs the dominant tool transceiver, 28′, to further send a wireless signal, 36′, to the linked tool transceiver, 34′, of the linked tool, 32′ (i.e., the 2^{nd} linked tool). The linked tool transceiver, 34′, of the linked tool, 32′, which then sends the signal to the controller, 30, which then may activate the power switch, 22. The linked tool, 32′, may also send a wireless signal, 36′, to the dominant tool, 20′, and/or may send a wireless signal, 36″, to the dominant tool, 20.

In an embodiment herein, the dominant tool can control from about 1 to about 32766 linked tools.

In an embodiment herein, the dominant tool power is variable and the linked tool power is variable; or wherein the variable activation of the dominant tool power switch corresponds to variable activation of the linked tool power switch. Thus, in an embodiment herein, the cooperation is triggered by analog switches where percent depression of the power switch in the dominant tool will equal the activation percentage. For example, if the dominant tool switch is pressed by anywhere from about 0 to about 100 percent, the linked tool(s) will be activated by the same amount (ranging from about 0 to about 100 percent); or if the dominant tool power switch is activated to 25 percent, then the linked tool power switch is activated by the same 25 percent.

In an embodiment herein, the power tool system will be set up by group from the owner. One or multiple nodes can be added or deleted from the system.

In an embodiment herein, the wireless communications node and the wireless receiver; or wireless transceiver(s) employ a security protocol to protect the signal(s), the wireless communication node, the wireless receiver, the wireless transmitter, the wireless transceiver, and/or the tool, etc. In an example herein, the security protocol is RTD 2.0. In an embodiment herein, the security protocol uses encryption.

### Example 1

In an embodiment of the present invention, a fan is provided as a linked tool. The sensor position is on the fan, and therefore the fan contains a humidity sensor and temperature sensor, a power switch, a speed switch, and a Wi-Fi transceiver, all operatively-connected to a controller and an AC power source. The dominant tool is a drill which contains a Wi-Fi transceiver which is operatively connected to a DC battery, a power switch, and a controller.

When the trigger-like power switch of the drill is activated, the controller instructs the drill's transceiver to send a wireless start signal via Wi-Fi that is received by the fan's transceiver and is sent to the fan's controller. The fan's controller receives input from the humidity sensor and temperature sensors and determines that the fan should be activated. The controller then activates the power switch of the fan and the fan is activated.

When the power switch of the drill is released and thereby deactivated, the drill's transceiver sends a wireless stop signal via Wi-Fi that is received by the fan's transceiver and is sent to the fan's controller. The fan's controller contains a predetermined period of time to delay deactivating the fan, and therefore the controller deactivates the power switch of the fan only after 5 minutes has passed from the time that the fan's controller receives the stop signal.

### Example 2

An embodiment of the present invention is similar to that seen in FIG. 1. More specifically, a vacuum and a floodlight are provided as linked tools, and a circular saw is provided as a dominant tool. The floodlight is set up to illuminate the area to be cut by the user, while the vacuum is held in a position so as to vacuum up the sawdust created by the circular saw during use. The circular saw, the floodlight and the vacuum all contain Bluetooth™ transceivers.

When the trigger-like power switch of the circular saw is activated, the controller instructs the circular saw's transceiver to send a wireless start signal via Bluetooth™ that is received by the vacuum's transceiver and is sent to the vacuum's controller. The floodlight's transceiver also receives the signal and sends it to the floodlight's controller. The controllers then respectively activate the power switch of the vacuum and the floodlight.

When the power switch of the circular saw is released and thereby deactivated, the circular saw's transceiver sends a wireless stop signal via Bluetooth™ that is received by the vacuum's transceiver and is sent to the vacuum's controller. The vacuum's controller contains a predetermined period of time to delay deactivating the vacuum, and therefore the controller deactivates the power switch of the vacuum only after 2 minutes has passed from the time that the vacuum's controller receives the stop signal. Similarly, the floodlight's transceiver also receives the stop signal and sends it to the floodlight's controller. The floodlight's controller contains a predetermined period of time to delay deactivating the power switch and therefore the controller deactivates the power switch of the floodlight only after 10 minutes has passed from the time that the floodlight's controller receives the stop signal.

### Example 3

In an embodiment of the present invention, an example similar to that of EXAMPLE 1, provides a drill as the dominant tool, and a fan as the linked tool. All details are the same as in EXAMPLE 1 except that the fan's controller calculates the predetermined period of time from the time that it receives the start signal. Also, the predetermined period of time is 15 minutes. Accordingly, the fan's controller deactivates the power switch of the fan 15 minutes after the time that the fan's controller receives the start signal, irrespective of when the drill's power switch is deactivated.

### Example 4

In an embodiment of the present invention, an example similar to that of EXAMPLE 1, provides a drill as the dominant tool and a fan as the linked tool. All details are the same as in EXAMPLE 1 except that the transceiver transmits the start signal, the stop signal, etc. to the user's mobile phone, which then forwards and/or retransmits the start signal, the stop signal, etc. to the linked tool, which in this case is the fan.

### Example 5

In an embodiment of the present invention, an example similar to that of EXAMPLE 1, provides a drill as the dominant tool and a fan as the linked tool. All details are the same as in EXAMPLE 1 except that the transceiver transmits the start signal, the stop signal, etc. to the cloud, which then forwards and/or retransmits the start signal, the stop signal, etc. to the linked tool, which in this case is the fan.

### Example 6

In an embodiment of the present invention, an example similar to that of EXAMPLE 1, provides a drill as the dominant tool and a fan as the linked tool. All details are the same as in EXAMPLE 1 except that the fan is a battery-operated fan, and when the battery runs low, the controller of the fan sends a signal to the drill, which then activates a visual notification, such as a visual notification on a small LED panel on the drill.

### Example 7

In an embodiment of the present invention, an example similar to that of EXAMPLE 2. All details are the same as in EXAMPLE 1 except that the circular saw is the dominant tool and the vacuum is the respective linked tool. In addition, the vacuum is also a dominant tool for the floodlight, which is the respective linked tool, as seen in FIG. 3.

Accordingly, when the trigger-like power switch of the circular saw is activated, the controller instructs the circular saw's transceiver to send a wireless start signal via Bluetooth™ that is received by the vacuum's transceiver and is sent to the vacuum's controller. The vacuum's controller then activates the power switch of the vacuum.

At the same time, when the switch of the vacuum is activated, the controller instructs the vacuum's transceiver to send a wireless start signal via Bluetooth™ that is received by the floodlight's transceiver and is sent to the floodlight's controller which then activates the power switch of the floodlight.

When the power switch of the circular saw is released and thereby deactivated, the circular saw's transceiver sends a wireless stop signal via Bluetooth™ that is received by the vacuum's transceiver and is sent to the vacuum's controller. The vacuum's controller contains a predetermined period of time to delay deactivating the vacuum, and therefore the controller deactivates the power switch of the vacuum only after 2 minutes has passed from the time that the vacuum's controller receives the stop signal. Similarly, the vacuum's transceiver sends a wireless top signal via Bluetooth™. The floodlight's transceiver receives the stop signal and sends it to the floodlight's controller. The floodlight's controller contains a predetermined period of time to delay deactivating the power switch and therefore the controller deactivates the power switch of the floodlight only after 10 minutes has passed from the time that the floodlight's controller receives the stop signal.

It should be understood that the above only illustrates and describes examples whereby the present invention may be carried out, and that modifications and/or alterations may be made thereto without departing from the spirit of the invention.

It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

1) A power tool system comprising:
A) a dominant tool comprising:
i) a dominant tool power switch; and
ii) a dominant tool transceiver operatively-connected to the dominant tool power switch; and
B) a linked tool comprising:
i) a linked tool power switch; and
ii) a linked tool transceiver operatively-connected to the linked tool power switch, wherein when the dominant tool power switch is engaged, the dominant tool transceiver sends a wireless signal; or a start signal, to the linked tool transceiver to activate the linked tool power switch.

2) The power tool system according to claim 1, wherein the dominant tool is selected from the group consisting of a spray device, a garden care device, a power tool, a cutting device, an applicator, a motor, a generator, and a combination thereof

3) The power tool system according to claim 1, wherein the linked tool is selected form the group consisting of a vacuuming device, a heating device, a lighting device, a sound device, and a combination thereof

4) The power tool system according to claim 1, wherein the dominant tool further comprises a battery operatively-connected to the dominant tool transceiver, wherein the battery is operatively-connected to the dominant tool power switch.

5) The power tool system according to claim 4, wherein the dominant tool transceiver is located in or near the battery of the dominant tool.

6) The power tool system according to claim 1, wherein the linked tool further comprises a battery operatively-connected to the linked tool transceiver, wherein the battery is operatively-connected to the linked tool power switch.

7) The power tool system according to claim 6, wherein the linked tool transceiver is located in or near the battery of the linked tool.

8) The power tool system according to claim 1, wherein the dominant tool further comprises a dominant tool controller, wherein the dominant tool controller is operatively-connected to the dominant tool transceiver and the dominant tool power switch.

9) The power tool system according to claim 1, wherein the linked tool further comprises a linked tool controller, wherein the linked tool controller is operatively-connected to the linked tool transceiver and the linked tool power switch.

10) The power tool system according to claim 1, wherein the dominant tool transceiver sends a wireless signal; or a stop signal, to the linked tool transceiver, to deactivate the linked tool power switch.

11) The power tool system according to claim 11, wherein the dominant tool transceiver and the linked tool transceiver communicate with a wireless technology selected from the group of near field communication (NFC), proximity card, radio frequency identification (RFID), Wi-Fi, Bluetooth™, ZigBee™, 3G, 4G, 5G, 6G, LTE, and a combination thereof

12) The power tool system according to claim 1, wherein the dominant tool transceiver periodically sends the wireless signal to the linked tool transceiver; or to multiple linked tool transceivers.

13) The power tool system according to claim 1, further comprising a sensor, the sensor optionally selected from the group consisting of a temperature sensor, a humidity sensor, a light sensor, an air quality sensor, a location sensor, a proximity sensor, a power sensor, a sound sensor, a pH sensor, an attitude sensor, a barometer, a level sensor, an angle sensor, a pressure sensor, an impact sensor, a hall effect sensor, a RPM sensor, and a combination thereof, and wherein the sensor generates data.

14) The power tool system according to claim 13, wherein the sensor is located at a sensor position selected from the group consisting of the dominant tool, the linked tool, and a combination thereof

15) The power tool system according to claim 13, wherein the linked tool comprises a controller, wherein the controller comprises an instruction set having a condition dependent on the data, and wherein when the controller receives a start signal and when the condition is satisfied, the controller executes the instruction set.

16) The power tool system according to claim 13, wherein the sensor generates data at a rate of from about 0.001 Hz to about 10,000 Hz.

17) The power tool system according to claim 13, wherein the data is transmitted to the dominant tool, the linked tool, or a combination thereof

18) The power tool system according to claim 15, wherein the instruction set is selected from the group consisting of a default instruction set and a user-defined instruction set; or wherein the user-defined instruction set is programmed from a programming location selected from the group selected from the group consisting of a mobile device, a control panel on the dominant tool, a control panel on the linked tool, a website, a cloud server, and a combination thereof

19) The power tool system according to claim 1, wherein the dominant tool and the linked tool form a mesh network, optionally wherein the wireless signal; or the start signal, is transmitted over the mesh network.

20) The power tool system according to claim 1, further comprising a plurality of wireless signals sent between the dominant tool and the linked tool.

21) The power tool system according to claim 1, wherein the dominant tool transceiver sends the wireless signal at a rate of from about 0.001 Hz to about 10,000 Hz.

22) The power tool system according to claim 1, wherein the linked tool transceiver receives a wireless signal at a rate of from about 0.001 Hz to about 10,000 Hz.

23) The power tool system according to claim 1, wherein the dominant tool comprises a controller operatively-linked to the dominant tool transceiver, wherein the linked tool comprises a controller operatively-linked to the linked tool transceiver, and wherein the controller operatively-linked to the linked tool transceiver checks for a wireless signal at a rate of from about 0.001 Hz to about 10,000 Hz.

24) The power tool system according to claim 1, wherein the dominant tool power is variable and the linked tool power is variable; or wherein the variable activation of the dominant tool power switch corresponds to variable activation of the linked tool power switch.

25) The power tool system according to claim 1, wherein the wireless signal is sent either directly from the dominant tool transceiver to the linked tool transceiver or broadcast to the entire network.

26) A mesh network comprising the power tool system according to claim 1.

27) The mesh network according to claim 26, wherein the dominant tool is a wireless communication node, wherein the linked tool is a wireless communication node, and wherein the number of wireless communication nodes is from about 2 to about 32767.

28) The mesh network according to claim 27, wherein a user may configure the communication nodes.

29) A method for controlling a linked tool comprising the steps of:
A) providing a dominant tool comprising:
i) a dominant tool power switch; and
ii) a dominant tool transceiver operatively-connected to the dominant tool power switch; and
B) providing a linked tool comprising:
i) a linked tool power switch; and
ii) a linked tool transceiver operatively-connected to the linked tool power switch;
C) transmitting a wireless signal; or a start signal, from the dominant tool transceiver to the linked tool transceiver;
D) receiving the wireless signal; or the start signal, by the linked tool transceiver; and
E) activating the linked tool power switch.

30) The method for controlling a linked tool according to claim 29, further comprising the step of deactivating the linked tool power switch.

31) method for controlling a linked tool according to claim 30, wherein the deactivating step further comprises the steps of transmitting a stop signal from the dominant tool transceiver to the linked tool transceiver, and receiving the stop signal by the linked tool transceiver, optionally wherein the step of deactivating the linked tool power switch occurs after a predetermined period of time has passed from the time that the linked tool transceiver receives the stop signal.

32) The method for controlling a linked tool according to claim 30, wherein the deactivating step occurs after a predetermined period of time has passed from the time that the linked tool transceiver receives the start signal.

33) method for controlling a linked tool according to claim 29, further comprising the step of activating a notification, wherein the notification optionally is selected form the group consisting of an audio notification, a visual notification, a vibratory notification, and a combination thereof

34) The method for controlling a linked tool according to claim 33, further comprising the step of deactivating the notification.

35) The method for controlling a linked tool according to claim 29, further comprising the step of communicating with a communications device selected from the group consisting of the internet, the cloud, a mobile device, and a combination thereof, optionally wherein the mobile device is selected from the group consisting of a mobile phone, a tablet computer, and a combination thereof.
